(19) United States
(12) Patent Application Publication
(10) Pub. No.: US 2021/0263316 A1
(43) Pub. Date: Aug. 26, 2021

(54) HEAD-MOUNTED DISPLAY HAVING VOLUME SUBSTRATE-GUIDED HOLOGRAPHIC CONTINUOUS LENS OPTICS WITH LASER ILLUMINATED MICRODISPLAY

(71) Applicant: LUMINIT LLC, TORRANCE, CA (US)

(72) Inventors: FEDOR DIMOV, TORRANCE, CA (US); JUAN RUSSO, TORRANCE, CA (US)

(21) Appl. No.: 16/800,531

(22) Filed: Feb. 25, 2020

(51) Int. Cl. G02B 27/01; G02B 5/32; F21V 8/00; G03H 1/02; G03H 1/22; G03H 1/04

(52) U.S. Cl. CPC G02B 27/0172; G02B 5/32; G02B 6/005; G02B 6/0025; G03H 1/0248; G02B 5/003; G03H 1/0402; G03H 1/0465; G02B 2027/0174; G02B 2027/0194; G03H 1/2202

(57) ABSTRACT

This application relates to a see-through head-mounted display using recorded substrate-guided holographic continuous lens (SGHCL) and a microdisplay with narrow spectral band source or laser illumination. The high diffraction efficiency of the volume SGHCL creates very high luminance of the virtual image.

### TECHNICAL FIELD

This application is directed to a monochrome or full-color Head-Mounted Display (HMD) featuring a volume substrate-guided holographic continuous lens (SGHCL) optics and a microdisplay with a narrow spectral band source or laser-based illumination.

### BACKGROUND

It is estimated that the combined revenues for sales of augmented reality (AR), virtual reality (VR), and smart glasses will approach $80 billion by the year 2025. About half of that revenue is directly proportional to the hardware of the devices and the optics are key. However, despite this huge demand, such devices remain difficult to manufacture and the quality is lacking. One reason is that traditional optical elements are limited to the laws of refraction and reflection, which require cumbersome custom optical elements that are difficult to fabricate to form a usable image in the wearer's visual field. Another reason is that refractive optical materials are heavy in weight. Still another reason is that current devices offer a narrow field of view. An additional reason is that current devices have significant color dispersion, crosstalk, and degradation. Yet another reason is that current designs based on diffractive or holographic optics have low diffraction efficiency (DE) of about only 10-15%. The low DE is due to the fact that diffractive and holographic optics are wavelength and angle selective being able to accept just ˜10-20 nm. However, the spectral wavelength bandwidth of the organic light emitting diodes (OLEDs) can exceed 70 nm. Furthermore, the OLEDs have a much larger diffused angle of ˜90°, whereas the diffractive and holographic optics can accept about ˜3-30° depending on the optical power of the optics. These limitations result in devices that are less than satisfactory.

Thus, there exists a need for an effective solution to the problem of the inability to manufacture and provide quality HMDs, which the present disclosure addresses.

### BRIEF SUMMARY

The present application is directed to a holographic substrate-guided head-mounted see-through display comprising (a) an image source comprising a microdisplay with narrow spectral band illumination; (b) an edge-illuminated transparent substrate, and; (c) a single volume holographic lens.

In one aspect, the holographic substrate-guided head-mounted see-through display comprises (a) an image source comprising a microdisplay with laser-based illumination; (b) an edge-illuminated transparent substrate comprising an angled edge or an index-matched transparent prism, and; (c) a volume holographic continuous lens comprising a reflection substrate-guided holographic continuous lens (SGHCL), which is index-matched to the substrate, and which is rotated 180° around a perpendicular axis of symmetry passing through the center of the SGHCL; wherein upon playback, an incident guided beam experiences total internal reflection and hits the SGHCL at Bragg condition.

The HMD of this application has several benefits and advantages. One benefit is the very high luminance of the virtual image. A second benefit is that the HMD is not subjected to glare when illuminated from the front with the bright sun or other lights. Another advantage is that the HMD is small, low profile, and lightweight. Still another is that there is a wide field-of-view (FOV) and larger eye relief so that regular eyeglasses can be worn with the HMD. Yet another advantage is that the DE is increased up to 8-fold. An additional advantage is that the color change across the FOV is eliminated. Another advantage is that the volume SGHCL accepts a much wider range of beam angles coming from the laser-based microdisplay compared to regular holographic lenses based on volume holograms, which have a small range of accepted angles.

### BRIEF DESCRIPTION OF THE DRAWINGS

FIG. 1 is an illustration of one embodiment of a vertical geometry of a full color, red green blue (RGB) HMD with RGB SGHCL and microdisplay with RGB narrow spectral band illumination. FIG. 2 is an illustration of a recording of a reflection RGB SGHCL for HMD with one guided spherical convergent beam and another spherical divergent beam. FIG. 3 illustrates the color mixing box for red, green and blue laser wavelengths.

2

FIG. 4 illustrates a reflection RGB SGHCL played back directly where the diffracted beam is on the same side as the playback beam.

FIG. 5 shows a diagram of a reflection RGB SGHCL being played back after the incident guided beam experiences total internal reflection where the diffracted beam is on the side opposite to the playback beam.

FIG. 6 is a photo of an example setup for recording a reflection RGB SGHCL.

FIG. 7 is a photo of an example setup for playback.

FIG. 8 shows a photo of an example of the retrieved virtual image captured with the camera.

### DETAILED DESCRIPTION OF EXEMPLARY EMBODIMENTS

The present application relates to an HMD having a volume (thick) SGHCL based on transparent holographic components (THC). The HMD can be full color (RGB) or monochrome with input of a single narrow spectral band source or laser wavelength for monochrome and three color (RGB) narrow spectral band source or laser beams for full color.

In one embodiment, the holographic substrate-guided head-mounted see-through display comprises (a) an image source comprising a microdisplay with narrow spectral band illumination; (b) an edge-illuminated transparent substrate, and; (c) a single volume holographic lens.

In another embodiment, the holographic substrate-guided head-mounted see-through display comprises (a) an image source comprising a microdisplay with laser-based illumination; (b) an edge-illuminated transparent substrate comprising an angled edge or an index-matched transparent prism, and; (c) a volume holographic continuous lens comprising a reflection substrate-guided holographic continuous lens (SGHCL), which is index-matched to the substrate, and which is rotated 180° around a perpendicular axis of symmetry passing through the center of the SGHCL; wherein upon playback, an incident guided beam experiences total internal reflection and hits the SGHCL at Bragg condition. In this embodiment, diffraction to the eyes occurs on the side of the substrate opposite to the side of the substrate near the microdisplay.

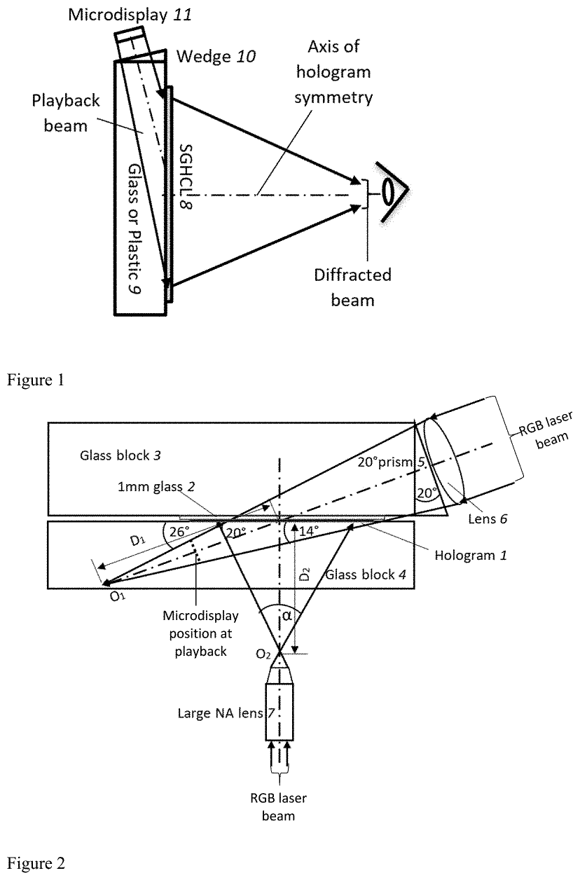

FIG. 1 illustrates an example of a RGB HMD having a volume RGB SGHCL with a microdisplay 11 with narow spectral band source RGB illumination in vertical geometry. The microdisplay 11 can be either laser-illuminated front-lit liquid crystal on silicon (LCOS), DLP, LED, or LCD with laser backlight. The substrate 9 is entirely transparent to provide wide see-through FOV and can be made from a number of materials, such as glass, quartz, acrylic plastic, polycarbonate plastic, or a mixture thereof. The substrate 9 can be a single plate or multiple plates and can have a variety of shapes including rectangular, oval, circular, tear-drop, hexagon, rectangular with rounded corners, square, or mixtures thereof. The side of the substrate 9 opposite to the eye can be anti-reflective (AR) coated to improve the see-through transmission. The substrate 9 also can be curved, as in prescription glasses, to correct for poor vision. A thin layer of concave glass with low refractive index can be attached to the bottom of the substrate 9 to make it compatible with prescription glasses. For a SGHCL 8 with n=1.49, the refractive index of this layer should be n=1.35 to create TIR at 25° The thickness of the substrate 9 can be in the range of about 3-6 mm but can be thicker if necessary. The substrate 9 can be made of a single unitary body or can comprise a plurality of bodies made of the same or different transparent materials. Some edges of the substrate 9 can also be coated with a light absorptive coating, such as a black paint. The substrate 9 can also contain a tint or dye.

The substrate 9 can be angled at one end or can further include a wedged prism 10 index-matched with the end of the substrate 9 at playback. The angled edge or attached wedged prism 10 serve to minimize aberrations of the beam refracting from air in glass and can vary from 15° to 25° depending on the playback angles, substrate 9 thickness, and SGHCL 8 size. The prism 10 can be a triangular prism or a trapezoidal prism. The prism 10 can be made from a number of materials, such as glass, quartz, acrylic plastic, polycarbonate plastic, or a mixture thereof. The prism 10 can be the same material and/or composition as the substrate 9, or it can be different from the substrate 9.

The RGB narrow spectral band source illuminated microdisplay 11 is positioned parallel to the angled edge of the substrate 9 or the surface of the wedged prism 10 so that central beam from the microdisplay 11 is perpendicular to the substrate edge 9 to also minimize aberration at refraction. The microdisplay 11 can be directly attached to the substrate 9 or there can be a gap between the microdisplay 11 and the substrate 9. This gap allows for adjustment of the microdisplay 11 along the optical axis for focusing of the virtual image and for changing its apparent image plane. In another embodiment, the microdisplay 11 can be a monochrome microdisplay.

A RGB SGHCL 8 is laminated to the surface of the substrate 9, facing the viewer's eyes. The SGHCL 8 can be covered with a thin ˜100 um layer of glass (like Corning willow glass) for protection, and this glass can be AR coated for improved transmission. The playback geometry with the microdisplay 11 on top of the substrate 9 takes advantage of the high definition multimedia interface (HMDI) resolution with the image aspect ratio 16:9. This correlates with a 3 mm substrate 9 thickness and a microdisplay 11 of size 5.16 mm×3 mm, positioned as shown. A reflection volume SGHCL was used since its angular selectivity is much lower than that of transmission volume holograms.

The FOV of the HMD with SGHCL can be much larger than the FOV of HMD with regular SGH optics. Also, the RGB HMD with SGHCL is much smaller and lighter than the RGB HMD with regular SGH because there is only one hologram used. The HMD can be monochrome or full color. In addition, the HMD can be monocular, biocular, or binocular. HMD with SGHCL optics is not subject to glare when illuminated from the front because the diffracted light is coupled in the substrate and doesn't reach the eyes. Reflection SGHCL in RGB HMD can work as transmission and provides flexibility in design and a larger eye relief, so regular eyeglasses can be worn underneath the HMD. Also, here the DE can be increased multifold up to about 8× greater. In addition, there is no color shift in the FOV and low power consumption due to the high DE.

FIG. 2 illustrates an example of a recording system with two spherical beams for one embodiment of a reflection RGB SGHCL with recording points O₁ and O₂. One recording RGB beam is convergent focused in point O₁ using long focus lens 6. Another RGB beam is divergent with focus in point O₂ created by lens 7 with large numerical aperture (F#<1) to create large FOV. Both beams should cover the thin holographic polymer 1, which is laminated to a glass substrate 2, which is index-matched to a glass block 3. A glass substrate of approximately 1 mm can be used for convenience and stability at hologram recording and can be eliminated at playback. A 15° to 25° wedged prism 5 is attached to the glass block 3 on a side adjacent to the side of the glass block 3 having the substrate 2 attached. In one embodiment, a 20° wedge prism is used. A second glass block 4 is placed underneath the SGHCL 1 to avoid reflection of the beam back from the bottom surface of the SGHCL 1. In order to experience TIR and become guided, the recording beams can have angles with the glass substrate 2 surface with the holographic polymer 1 laminated therein not larger than 48° because the TIR angle for the border between air and glass is about 42°. The minimal angle with the glass substrate 2 surface with the holographic polymer 1 laminated should not be very small (<12°) because even tiny differences in the refractive index between the glass and the holographic polymer will make propagating of the shallow guided beam problematic, especially considering that the refractive indices of the holographic material are slightly different before and after recording (Δn˜0.03). The guided beams should propagate reliably during both recording and playback. The reliable guided angles should be >12° for the holographic material that is used with the average refractive index n ˜1.48. In this example, the angle with the SGHCL of the central beam of the spherical guided beam is 20° and a wedged 20° prism attached to the glass block 3 is used to minimize aberrations of the spherical beam refracting from air in glass. Minimal and maximal angles in the medium of the convergent beam are 14° and 26° respectively. The angle a of the divergent beam created using large numerical aperture (NA) lens 7 is chosen to create the required FOV at playback.

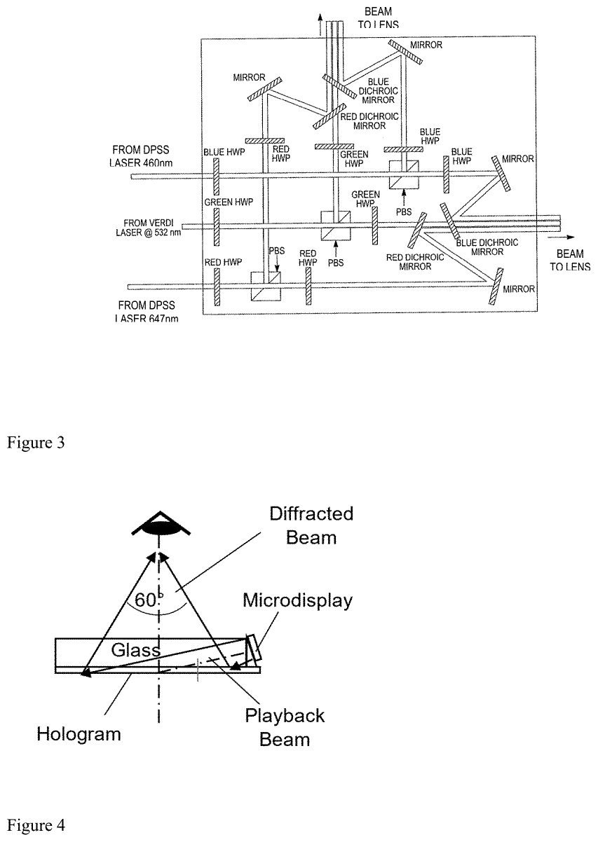

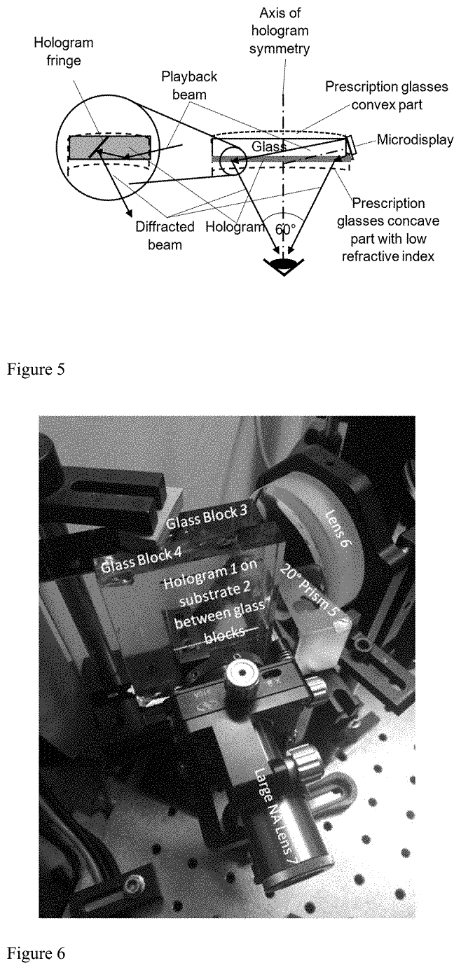

FIG. 3 illustrates the color mixing box to create two RGB laser beams for hologram recording. After recording and processing of this reflection SGHCL, it is played back, as shown in FIGS. 4 and 5.

FIG. 4 illustrates a reflection RGB SGHCL played back directly where the diffracted beam is on the same side of the SGHCL as the playback beam from the microdisplay hitting the thick reflection SGHCL at Bragg condition and diffracting up to the viewer's eyes.

In FIG. 5, the reflection RGB SGHCL is rotated 180° around an axis of symmetry passing through the center of the SGHCL perpendicular to it sides. The playback guided beams impinge on the SGHCL not at Bragg, experience total internal reflection, then they are at Bragg and diffract efficiently down to the eyes. Upon playback, the SGHCL has a diffracted beam and a playback beam on a different side of the SGHCL. To the left on the Figure is a magnified excerpt showing one ray of the playback beam experiencing TIR and reflecting from the SGHCL fringe. Here, reflection SGH works as transmission. Also, the eye relief is increased a few millimeters, nearly by the thickness of the glass substrate. The reflection SGHCL helps to increase the FOV due to the lower angular selectivity as compared to transmission holograms.

In FIG. 6 is shown a photograph of the setup for recording reflection monochrome SGHCL with 532 nm laser beams. The schematic of FIG. 2 was followed to build the proof of concept monochrome recording holographic setup. There a holographic polymer for recording SGHCL 1 is laminated on 1 mm substrate 2, which is index matched to glass block 3. A 20° prism 5 is placed at one end of glass block 3. Glass block 4 is placed opposite the holographic polymer 1 to exclude TIR of the convergent guided beam from the external side of the hologram and avoid recording unwanted transmission substrate-guided hologram.

For playback, the narrow spectral band source phase conjugate to the recording convergent beam is used. A microdisplay is placed closer to the recorded SGHCL as compared to the recording point O₁ as shown in FIG. 2. By positioning the microdisplay closer to the SGHCL, all the field points of the microdisplay comply with Bragg condition with recorded SGHCL because the entire area where the display is positioned in the vertical direction is covered with the recording beams. Because of this shift from the distance Di to be closer to the SGHCL, the range of field points beams from the microdisplay in Bragg-degeneration direction, accepted by the thick hologram increases. Also, the retrieved beams become collimated, diffracting on the created fringes when the beam that converges to the point O₁ interferes with the beam that diverges from point O₂. This is an advantage of the continuous lens as compared to the regular holographic lens that is usually recorded with one collimated beam and another spherical beam. To create collimated retrieved beams, the microdisplay is placed at a distance F_{EQV} from the SGHCL satisfying the following Eq. (1):

1/F_{EQV}=1/D₁+1/D₂ (1)

where D₁ and D₂ are shown in FIG. 2, and F_{EQV} is equivalent focus of the recorded SGHCL. A magnified virtual image of the microdisplay is seen as coming from infinity with each point of the virtual image formed with a collimated beam. Collimated beams are created when the playback point source is moved from the position in O₁ to the position of the equivalent focus F_{EQV}.

Depending on the aspect ratio of the microdisplay image, the microdisplay can be placed either at the horizontal or vertical edge of the glass substrate complying with the recorded Bragg plane of the SGHCL. For the HDMI resolution 16(H):9(V) with the vertical image size almost 2× smaller that the horizontal size, it is better to place the microdisplay on the top of the glass substrate. This will ensure the largest vertical FOV (based on the Bragg angular selectivity) and rather thin substrate (based on the minimal guided angle). The horizontal FOV SGHCL doesn't limit significantly, because the angular selectivity is much lower in the non-Bragg degeneration direction. Depending on the HMD geometry and necessity to adjust the focusing by moving the microdisplay, the microdisplay can be either directly attached to the waveguide as shown in FIGS. 4 and 5, or there can be a gap between the microdisplay and the waveguide permitting adjustment of the focus dynamically, as shown in FIG. 1.

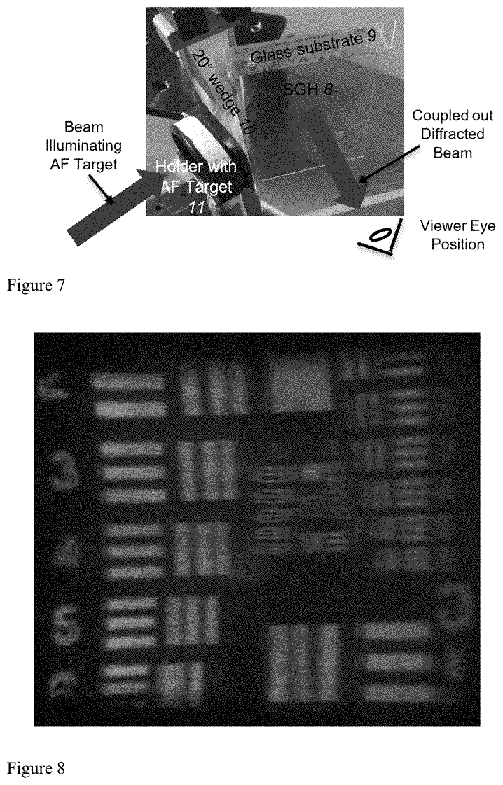

FIG. 7 is a photo of the playback setup based on the geometry shown in FIG. 1 for testing of the recorded SGHCL using a USAF Resolution Test Target with different spatial frequency of black and white line pairs. Shown is a glass substrate 9 having the SGHCL 8 with a 20° wedged prism 10 attached to the substrate 9. A holder 11 is attached to the wedged prism 10. A beam illuminates the USAF Target and travels through the wedge into the glass substrate and through the SGHCL coupling out where the retrieved diffracted beam is seen by the viewer's eyes and can be captured with the camera.

Example of the retrieved virtual image captured with the camera is shown in FIG. 8. Some image blurriness in FIG. 8 may come from the inaccurate focusing by the camera to the virtual image. Existent distortion can be eliminated either by implementing fabricated holograms or by pre-distorting the microdisplay image. Estimated FOV of the virtual image is >60°. This is the largest FOV ever achieved in SGHCL HMD using a single hologram. Also, RGB HMD is possible with reflection continuous lens. Similar RGB SGHCL HMD can be realized by using RGB laser beams for SGHCL recording and playback. At playback the laser wavelengths should be adjusted, because at post-exposure processing hologram shrinks, and the playback wavelengths that are in Bragg should be shorter by a few nanometers.

In another aspect, this application is directed to a method of recording a volume holographic lens comprising shining two spherical beams onto a holographic polymer index-matched to a substrate, wherein a first recording beam is guided from an edge of the substrate and convergent to a first focus point and a second recording beam is divergent from a second focus point, and wherein both beams cover the holographic polymer. In one embodiment of the method of recording the volume holographic lens, the substrate is index-matched to a first rectangular block having an angled edge or an index-matched prism; a first recording beam is guided and convergent with focus in a recording point O₁ using a long focus lens and a second recording beam is divergent with focus in a recording point O₂ created by a lens with a large numerical aperture and small F#<1; a second rectangular block is placed underneath the holographic polymer to avoid total internal reflection of a guided beam back from a bottom surface of the holographic polymer to avoid recording unwanted transmission SGHCL; the recording convergent beam comprises angles with the substrate and holographic polymer less than or equal to about 48°; a reliable guided angle is greater than about 12°; a microdisplay is positioned at equivalent focus of the two recording spherical beams; an HMD image comprises a virtual image coming from infinity; and a minimum angle of a convergent beam with a holographic polymer surface comprises about 14° and a maximal angle of the convergent beam with the holographic polymer surface comprises about 31° with a central beam having 15°-25° angle.

Alternative embodiments of the subject matter of this application will become apparent to one of ordinary skill in the art to which the present invention pertains without departing from its spirit and scope. It is to be understood that no limitation with respect to specific embodiments shown here is intended or inferred.

We claim:

1. A holographic substrate-guided head-mounted see-through display comprising:
(a) an image source comprising a microdisplay with narrow spectral band illumination;
(b) an edge-illuminated transparent substrate, and;
(c) a single volume holographic lens.

2. The holographic substrate-guided head-mounted see-through display of claim 1 wherein:
(a) the image source comprises a microdisplay with laser-based illumination;
(b) the edge-illuminated transparent substrate comprises an angled edge or an index-matched transparent prism, and;
(c) the single volume holographic lens comprises a reflection substrate-guided holographic continuous lens (SGHCL), which is index-matched to the substrate, and which is rotated 180° around a perpendicular axis of symmetry passing through the center of the SGHCL;
wherein upon playback, an incident guided beam experiences total internal reflection and hits the SGHCL at Bragg condition.

3. The holographic substrate-guided head-mounted display of claim 1 wherein the substrate comprises a thickness of about 3-6 mm.

4. The holographic substrate-guided head-mounted display of claim 2 wherein the substrate and the prism each comprise glass, quartz, acrylic plastic, polycarbonate plastic, or a mixture thereof.

5. The holographic substrate-guided head-mounted display of claim 1 wherein the substrate comprises a single plate or multiple plates.

6. The holographic substrate-guided head-mounted display of claim 1 wherein the substrate comprises a 15°-25° angled edge or a 15°-25° index-matched prism.

7. The holographic substrate-guided head-mounted display of claim 1 wherein the microdisplay comprises a laser-illuminated LCOS, DLP, LED, or LCD.

8. The holographic substrate-guided head-mounted display of claim 1 wherein a side of the substrate, opposite to an eye of the viewer, comprises an anti-reflective coating.

9. The holographic substrate-guided head-mounted display of claim 1 wherein the substrate comprises a curved shape.

10. The holographic substrate-guided head-mounted display of claim 1 wherein the substrate comprises prescription glasses.

11. The holographic substrate-guided head-mounted display of claim 1 wherein the substrate comprises a unitary body or a plurality of bodies made of the same material or different materials.

12. The holographic substrate-guided head-mounted display of claim 1 wherein one or more edges of the substrate comprise a light absorptive coating.

13. The holographic substrate-guided head-mounted display of claim 1 wherein the microdisplay is directly attached to the substrate or comprises a gap relative to the substrate.

14. The holographic substrate-guided head-mounted display of claim 2 wherein the SGHCL comprises a first side and a second side opposite to the first side; and wherein, upon playback, the SGHCL has a diffracted beam on the first side and has a playback beam on the second side.

15. The holographic substrate-guided head-mounted display of claim 2 wherein, upon playback, the SGHCL has a diffracted beam and a playback beam on a same side.

16. The holographic substrate-guided head-mounted display of claim 1 wherein the substrate comprises a shape including rectangular, oval, circular, tear-drop, hexagon, rectangular with rounded corners, square, or a mixture thereof.

17. The holographic substrate-guided head-mounted display of claim 1 wherein the microdisplay comprises a monochrome or a RGB (full color) microdisplay.

18. The holographic substrate-guided head-mounted display of claim 1 wherein a retrieved image comprises a monochrome or RGB (full-color) image.

19. A method of recording a volume holographic lens comprising shining two spherical beams onto a holographic polymer index-matched to a substrate, wherein a first recording beam is guided from an edge of the substrate and convergent to a first focus point and a second recording beam is divergent from a second focus point, and wherein both beams cover the holographic polymer.

20. The method of recording the volume holographic lens of claim 19 wherein the substrate is index-matched to a first rectangular block having an angled edge or an index-matched prism;
wherein a first recording beam is guided and convergent with focus in a recording point Oi using a long focus lens and a second recording beam is divergent with focus in a recording point 02 created by a lens with a large numerical aperture and small F#<1;
wherein a second rectangular block is placed underneath the holographic polymer to avoid total internal reflection of a guided beam back from a bottom surface of the holographic polymer to avoid recording unwanted transmission SGHCL;
wherein the recording convergent beam comprises angles with the substrate and holographic polymer less than or equal to about 48°;
wherein a reliable guided angle is greater than about 12°;
wherein a microdisplay is positioned at equivalent focus of the two recording spherical beams;
wherein an HMD image comprises a virtual image coming from infinity; and
wherein a minimum angle of a convergent beam with a holographic polymer surface comprises about 14° and a maximal angle of the convergent beam with the holographic polymer surface comprises about 31° with a central beam having 15°-25° angle.
